(19) United States
(12) Patent Application Publication
(10) Pub. No.: US 2017/0127846 A1
(43) Pub. Date: May 11, 2017

(54) METHODS AND SYSTEMS RELATING TO LIFTING AIDS

(71) Applicant: LISA CAROLYN WALL, GATINEAU (CA)

(72) Inventor: LISA CAROLYN WALL, GATINEAU (CA)

(21) Appl. No.: 15/342,568

(22) Filed: Nov. 3, 2016

Related U.S. Application Data
(60) Provisional application No. 62/251,278, filed on Nov. 5, 2015.

(51) Int. Cl. A47C 21/02; B66F 3/00

(52) U.S. Cl. CPC A47C 21/028; B66F 3/00

(57) ABSTRACT

Whilst prior art solutions have been proposed to address the problem of lifting mattresses etc. whilst making the bed with the sheets these employ solid implements, which either interfere with the bed making process and must be removed post-use, or involve expensive machinery to inflate and lift the upper bedding component. Beneficially, the invention provides for a means of gaining a mechanical advantage in making the lift in a device that could in different instances be left in-situ, form part of the lower or upper bedding component, and support disguise through enclosure in fabrics matching bedding with low cost and ease of use. It would be further beneficial for the opening mechanism to be reliable enough that it reliably deploys fully when used by even the frailest of individuals.

### CROSS-REFERENCE TO RELATED APPLICATIONS

This patent application claims the benefit of priority from U.S. Provisional Application 62/251,278 filed Nov. 5, 2015 entitled “Methods and Systems Relating to Lifting Aids” the entire contents of which are incorporated herein by reference.

### FIELD OF THE INVENTION

This invention relates to lifting devices and more particularly to a lifting device supporting use during the changing of bedding and remaining in place for subsequent use.

### BACKGROUND OF THE INVENTION

The changing of bedding (sheets, covers, etc.), involves the lifting or elevating of bedding components (for example, lifting a mattress with respect to an underlying box spring) which can be difficult even for able bodied individuals, let alone the infirm, the elderly or disabled. These challenges may be magnified in certain settings, such as for professional housekeeping employees for example, who may need to turn around many rooms in a short period of time, including changing sheets on many beds. Moreover, each bed requires the housekeeping employee to repeatedly lift the bed mattress to tuck sheets between the mattress and box spring. With little time to spare, housekeeping employees want to perform such lifts, in addition to other duties, quickly and efficiently. Even at home most households have at least one bed and potentially 2, 3, 4 or more with similar issues to address, whilst increasing age of the householder makes the required effort increasingly difficult.

Whilst prior art solutions have been proposed to address this lifting problem, they employ the use of solid implements, which either interfere with the bed making process and must be removed post-use, or involve expensive machinery to inflate and lift the upper bedding component. Accordingly, it would be beneficial to provide a means of gaining a mechanical advantage in making the lift in a device that could in different instances be left in-situ, form part of the lower or upper bedding component, and support disguise through enclosure in fabrics matching bedding with low cost and ease of use. It would be further beneficial for the opening mechanism to be robust and easy enough that it reliably deploys fully when used by even the frailest of individuals.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to lifting devices and more particularly to a lifting device supporting use during the changing of bedding and optionally remaining in place for subsequent use.

In accordance with an embodiment of the invention there is provided a lifting device comprising:

a lower element having a first end, a second end, an upper surface and a lower surface;
an upper element having a first end, a second end, an upper surface and a lower surface;
a hinge joining the first end of the lower element to the first end of the upper element; and
a stand pivotally joined to a predetermined location on the upper end, wherein
in a first closed configuration the upper surface of the lower element and the lower surface of the upper element are disposed adjacent to each other and the stand is contained within at least one of a recess in the upper surface of the lower element, a recess in the lower surface of the upper element, and a cut-out in the upper element; and
in a second configuration the lower and upper elements are disposed at a predetermined angle with respect to each other and the stand is disposed between the lower and upper elements and retained in position by a feature within the upper surface of the lower element such that the second configuration is maintained when a load is applied to the upper surface of the upper element when the lifting device is mounted onto a surface.

In accordance with an embodiment of the invention there is provided a lifting device comprising:

a lower element having a first end, a second end, an upper surface and a lower surface;
an upper element having a first end, a second end, an upper surface and a lower surface;
a hinge joining the first end of the lower element to the first end of the upper element; and
a stand pivotally attached to a predetermined location on the upper end, wherein
in a first closed configuration the upper surface of the lower element and the lower surface of the upper element are disposed adjacent to each other and the lower end of the stand is disposed within at least one of a first recess and a cut-out in the upper surface of the lower element; and
in a second configuration the lower and upper elements are disposed at a predetermined angle with respect to each other and the stand is disposed between the lower and upper elements and retained in position within a second recess within the upper surface of the lower element such that the second configuration is maintained when a load is applied to the upper surface of the upper element when the lifting device is mounted onto a surface.

In accordance with an embodiment of the invention there is provided a device comprising:

a lower element having a first end, a second end, an upper surface and a lower surface;
an upper element having a first end, a second end, an upper surface and a lower surface;
a hinge joining the first end of the lower element to the first end of the upper element; and
a stand pivotally attached to a predetermined location on the upper end, wherein
in a first closed configuration the upper surface of the lower element and the lower surface of the upper element are disposed at a first predetermined angle with respect to each other and the lower end of the stand is disposed within the region between the upper surface of the lower element and the lower surface of the upper element; and
in a second configuration the lower and upper elements are disposed at a predetermined angle with respect to each other and the stand is disposed between the lower and upper elements and retained in position when a load is applied to the upper surface of the upper element when the lifting device is mounted onto a surface.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIGS. 1A, 1B, 2 and 3 depict embodiments of the invention in closed and open configurations;

FIGS. 4 and 5 depict the piece parts required for implementing a lifting device according to an embodiment of the invention as depicted in FIGS. 1A, 1B, 2 and 3;

FIG. 6 depicts an embodiment of the invention in open configuration;

FIG. 7 depicts an embodiment of the invention in open and closed configurations;

FIG. 8 depicts an end elevation of the embodiment of the invention in FIG. 7 and another embodiment of the invention;

FIG. 9 depicts an embodiment of the invention;

FIG. 10 depicts embodiment of the invention;

FIG. 11A depicts the piece parts for implementing a lifting device according to an embodiment of the invention;

FIGS. 11B and 11C depict the lifting device according to an embodiment of the invention exploiting the piece parts depicted in FIG. 11A in closed and open positions respectively;

FIG. 12 depicts sheet protector elements for use in conjunction with lifting devices according to embodiments of the invention;

FIG. 13 depicts hinge elements according to embodiments of the invention for use in conjunction with a lifting device according to another embodiment of the invention; and

FIG. 14 depicts a configuration exploiting springs to aid the user in operating the lifting device according to an embodiment.

### DETAILED DESCRIPTION

The present invention is directed to lifting devices and more particularly to a lifting device supporting use during the changing of bedding and optionally remaining in place for subsequent use.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “bedding component” as used herein, and throughout this disclosure, refers to an element of a bed. This includes, but is not limited to a box-spring, divan, bed base, slatted or slotted bed base and a bedframe but can include a floor where a mattress is disposed directly onto it.

A “mattress” as used herein, and throughout this disclosure, refers to a large pad for supporting the reclining body, used as or on a bed. This includes, but is not limited to, mattresses formed from a quilted or similarly fastened case, usually of heavy cloth, that contains hair, straw, cotton, foam rubber, latex, polyurethane foams etc. or a framework of metal springs. It may include those that are inflatable or filled with water.

A “sheet” also known as a “bed sheet” as used herein, and throughout this disclosure, refers to a cloth, usually rectangular, used to cover a mattress and those sleeping upon it. They are the sheets which one typically lays between when a second flat bed sheet is laid on top of the sheet covering the mattress. When a second sheet is used, the top one is known as the top sheet and the sheet covering the mattress is known as the bottom sheet. If the bottom sheet is pre-sewn or elasticated to fit snugly over the mattress, it is known as a fitted sheet. Blankets, quilts, duvets, comforters and other bed covers are placed on top of the top sheet.

A “lifting device” as used herein, and throughout this disclosure, refers to an aid for a user allowing them to lift and hold raised a first item, e.g. a mattress, relative to a second, e.g. box-spring allowing the user to perform one or more tasks, such as cleaning, accessing beneath the first item, covering or uncovering the first item, e.g. tucking or untucking a sheet under the edge of the mattress when making the bed or removing soiled bedsheets and dressing the bed with fresh ones.

“Polyester” as used herein, and throughout this disclosure, refers to a category of polymers that contain the ester functional group in their main chain. This includes, but is not limited to polyesters which are naturally occurring chemicals as well as synthetics through step-growth polymerization, for example. Polyesters may be biodegradable or not. Polyesters may be a thermoplastic or thermoset or resins cured by hardeners. Polyesters may be aliphatic, semi-aromatic or aromatic. Polyesters may include, but not be limited to, those exploiting polyglycolide, polylactic acid (PLA), polycaprolactone (PCL), polyhydroxyalkanoate (PHA), polyhydroxybutyrate (PHB), polyethylene adipate (PEA), polybutylene succinate (PBS), polyethylene terephthalate (PET), polybutylene terephthalate (PBT), polytrimethylene terephthalate (PTT), and polyethylene naphthalate (PEN).

A “thermoplastic” or “thermosoftening plastic” as used herein and throughout this disclosure, refers to a category of polymers that become pliable or moldable above a specific temperature and solidify upon cooling. Thermoplastics may include, but not be limited, polycarbonate (PC), polyether sulfone (PES), polyether ether ketone (PEEK), polyethylene (PE), polypropylene (PP), poly vinyl chloride (PVC), polytetrafluoroethylene (PTFE), polyimide (PI), polyphenylsulfone (PPSU), polychlorotrifluoroethene (PCTFE or PTFCE), florinated ethylene propylene (FEP), and perfluoroalkoxy alkane (PFA).

A “metal” as used herein, and throughout this disclosure, refers to a material that has good electrical and thermal conductivity. Such materials may be malleable and/or fusible and/or ductile. Metals may include, but not be limited to, aluminum, nickel, copper, cobalt, chromium, silver, gold, platinum, iron, zinc, titanium, and alloys thereof such as bronze, stainless steel, stainless stainless steel, brass, and phosphor bronze.

A “silicone” as used herein, and throughout this disclosure, refers to a polymer that includes any inert, synthetic compound made up of repeating units of siloxane.

An “elastomeric” material or “elastomer” as used herein, and throughout this disclosure, refers to a material, generally a polymer, with viscoelasticity. Elastomers may include, but not be limited to, unsaturated rubbers such as polyisoprene, butyl rubber, ethylene propylene rubber, silicone rubber, fluorosilicone rubber, fluoroelastomers, perfluoroelastomers, and thermoplastic elastomers.

A “scaffold” or “scaffolds” as used herein, and throughout this disclosure, refers to a structure that is used to hold up, interface with, or support another material or element(s). This includes, but is not limited to, such two-dimensional (2D) structures such as substrates and films, three-dimensional (3D) structures such as geometrical objects, non-geometrical objects, combinations of geometrical and non-geometrical objects, naturally occurring structural configurations, and manmade structural configurations. A scaffold may be solid, hollow, and porous or a combination thereof. A scaffold may contain recesses, pores, openings, holes, vias, and channels or a combination thereof. A scaffold may be smooth, textured, have predetermined surface profiles and/or features. A scaffold may be intended to support one or more other materials, one or more films, a multilayer film, one type of particle, multiple types of particles etc. A scaffold may include, but not be limited to, a spine of a device and/or a framework, for example, which also supports a shell and/or a casing.

A “shell” as used herein, and throughout this disclosure, refers to a structure that is used to contain and/or surround at least partially and/or fully a number of elements within embodiments of the invention. A shell may include, but not limited to, a part or parts that are mounted to a scaffold or scaffolds that support elements within a device according to an embodiment of the invention.

A “casing” as used herein, and throughout this disclosure, refers to a structure surrounding a scaffold and/or shell. This includes structures typically formed from an elastomer and/or silicone to provide a desired combination of physical tactile surface properties to the device it forms part of and other properties including, but not limited to, hermeticity, liquid ingress barrier, solid particulate ingress barrier, surface sheen, and colour. A casing may include, but not limited to, a part or parts that are mounted to a scaffold or scaffolds and/or a casing or casings forming part of a device according to an embodiment of the invention.

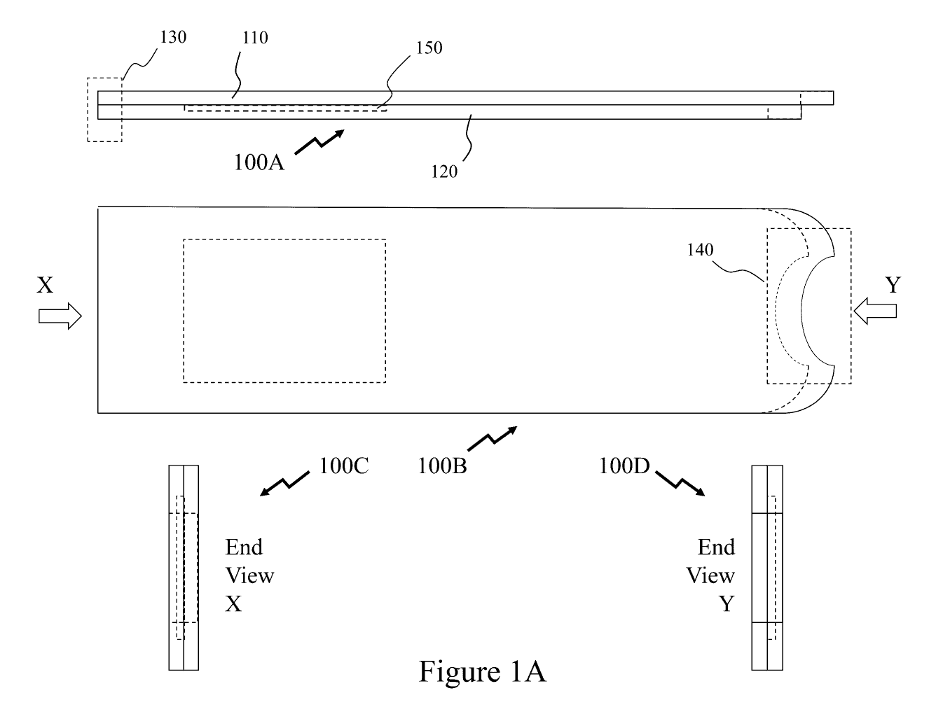

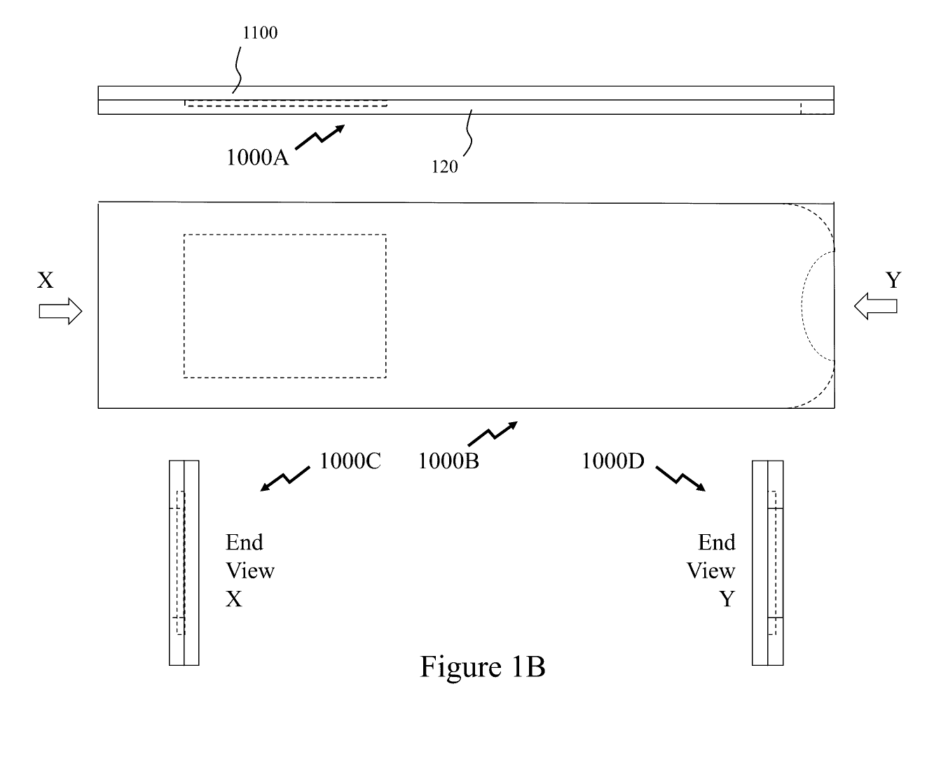

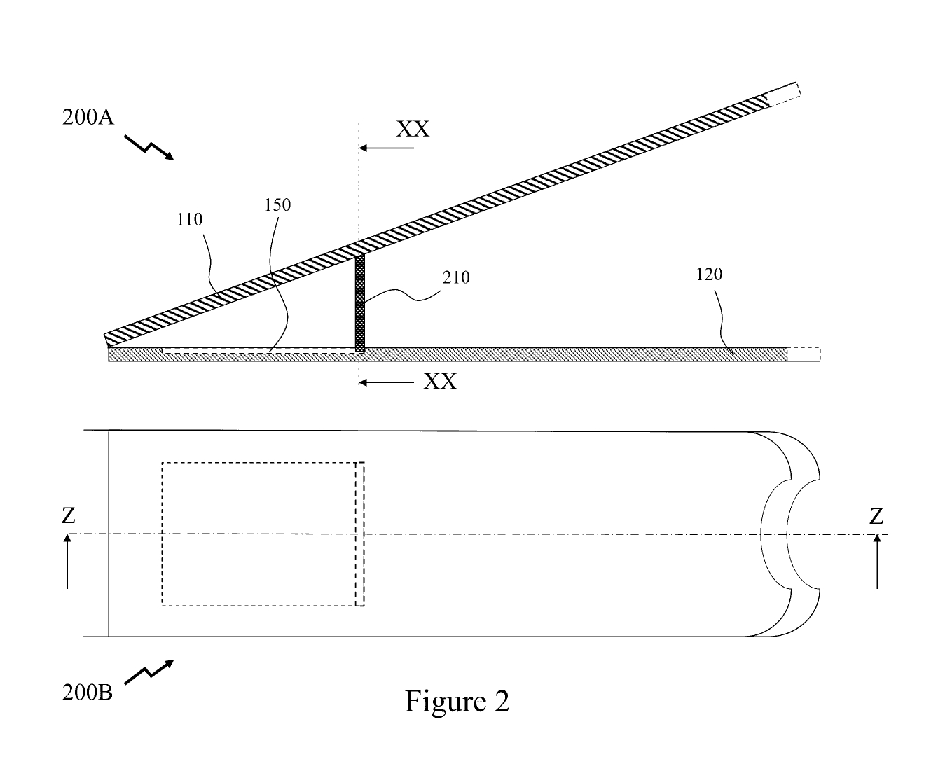

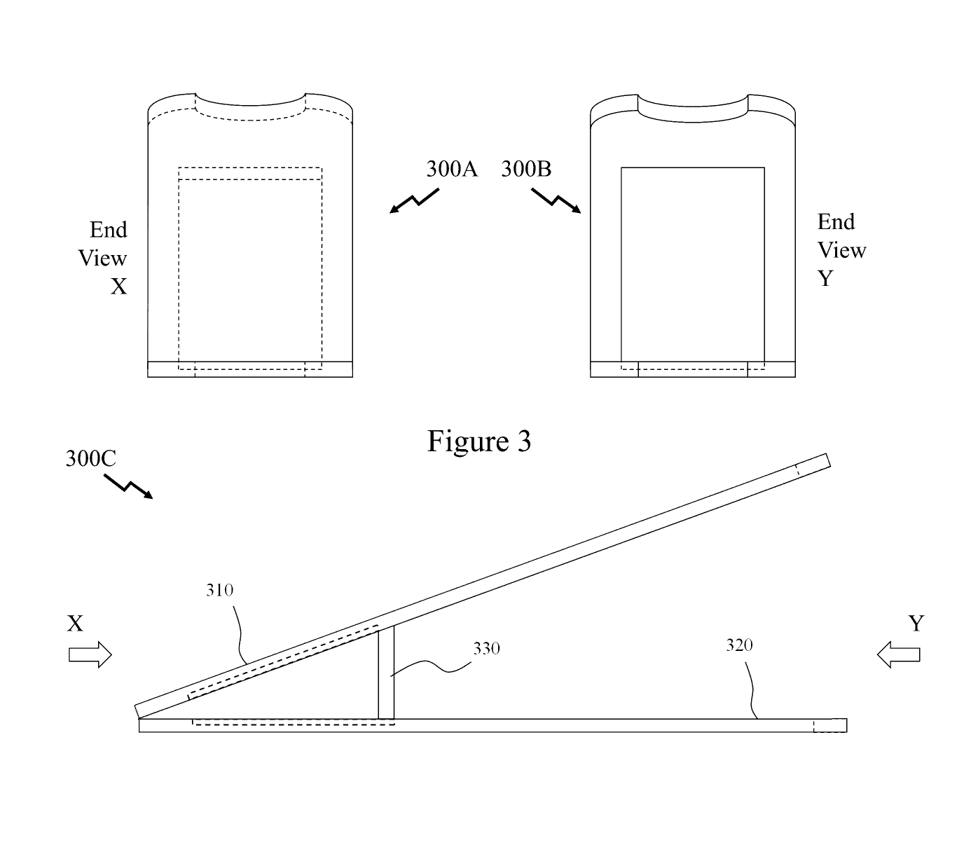

Referring to FIGS. 1A, 1B, 2 and 3 there are depicted embodiments of the invention in closed and open configurations. Considering initially FIG. 1A then there are depicted first to fourth views 100A to 100D respectively representing side, top, left and right elevations respectively for the closed configuration. As depicted the lifting device comprises an upper member 110 and a lower member 120 joined at one end by a hinge 130. The end of the upper and lower members 110 and 120 respectively forming a grip 140 due to the overhang of the upper member 110 relative to the lower member 120. Disposed within the lower member 120 is a region 150. Now referring to FIG. 2 there is depicted the lifting device of FIG. 1A in open configuration in side and plan elevations 200A and 200B respectively. Accordingly, it is evident that the region 150 in the closed configuration houses stand 210 which in the open configuration maintains the lifting device in the open configuration. The left and right end elevations of the lifting device of the embodiment of the invention depicted in FIGS. 1A and 2 are presented in first and second images 300A and 300B within FIG. 3. Third image 300C depicts a variant wherein the region 150 is now within both the upper and lower elements 310 and 320 respectively allowing for an increased thickness within the stand 330 whilst still allowing the device to fold flat when in the closed configuration.

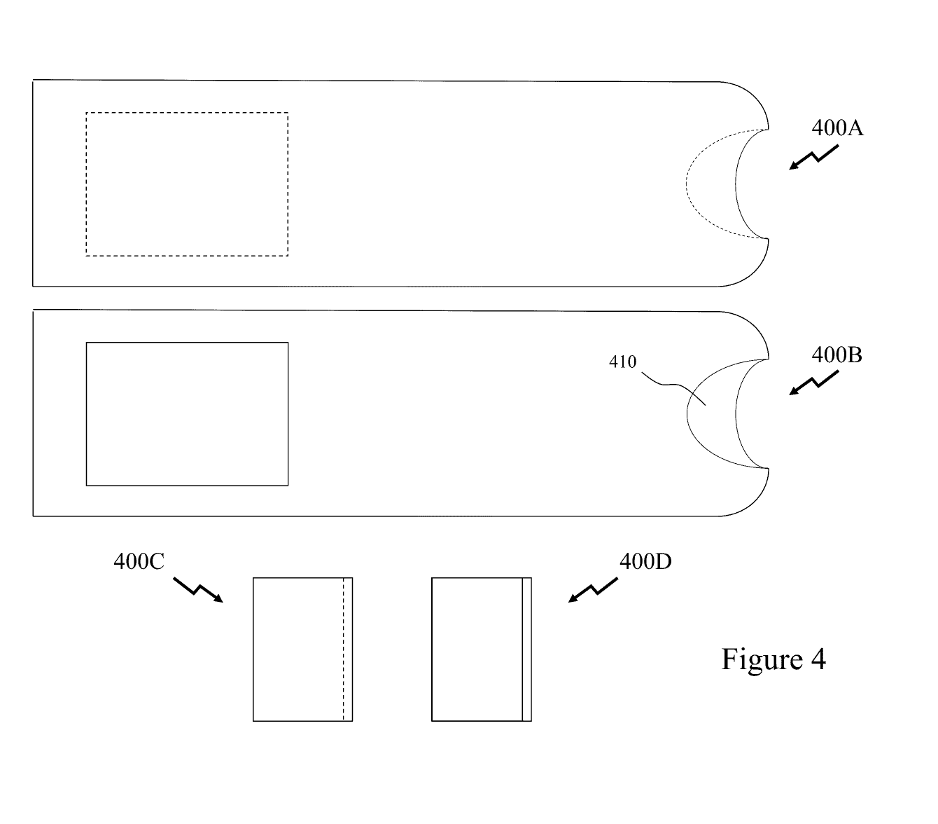

It would be evident that the upper and lower members 110 and 120 may be designed to be the same length through a cut-out in the lower member 120 relative to the upper member 110 projecting in that region. Optionally, in other designs as described and depicted below the gap between the upper and lower members may provide sufficient clearance for the user's fingers to attain grip and lift the upper member. Within FIG. 4 this is through the “groove” 410 wherein when assembled with a second element inverted the pair of “grooves” 410 provide a recess for the user's fingers to fit within and then lift the upper element.

Within FIG. 1B there is depicted a variant of the embodiment of the invention depicted in FIGS. 1A, 2 and 3 wherein in first to fourth images 1000A to 1000D an upper element 1100 is depicted with the lower element 120. In contrast to the upper element 110 in FIG. 1A the upper element 1100 has no grip region such that the insertion of the user's fingers beneath the upper element 1100 within the grip 140 of the lower element 120 allows them to apply lifting of the upper element 1100 and operation of the lifting device.

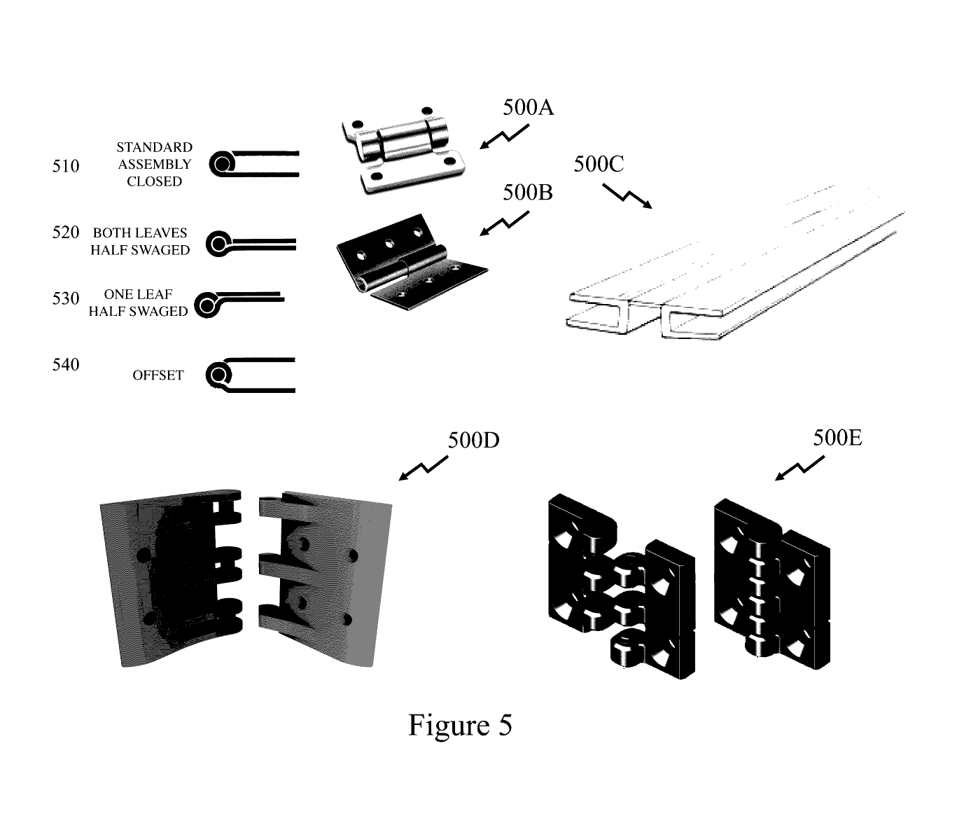

FIGS. 4 and 5 depict the piece parts required for implementing a lifting device according to an embodiment of the invention as depicted in FIGS. 1 to 3 according to the variant in third image 300C in FIG. 3. As such it consists of upper element 400A, lower element 400B, and a stand depicted in first and second views 400C and 400D. The stand is coupled, typically, to the upper element 400A such that when the upper element is lifted the stand drops down and supports the bedding element when the user releases the upper element. With the design in third image 300C the upper and lower elements 400A and 400B respectively are an identical part viewed from top and bottom thereby reducing manufacturing complexity further where the stand is formed as a separate piece-part and attached. The upper and lower elements 400A and 400B respectively are joined by a hinge element as are the stand and, typically, upper element 400A. Examples of hinges supporting embodiments of the invention are depicted in first to fifth images 500A to 500E respectively in FIG. 5. First and second images 500A and 500B in FIG. 5 depict a hinge comprising, typically, two elements that are joined by a pin or rod. As is evident from first to fourth configurations 510 to 540, representing a subset of potential configurations, these can be sourced based upon not only dimensions such as length, width, thickness, number of fitting locations, material etc. but also by whether the two “plates” of the hinge when facing one another are in so-called standard assembly (closed), both leaves half-swaged, one leaf half swaged, and offset which define whether a gap exists and the position of the plates relative to the pin. Also depicted is a so-called “living” hinge in third image 500C or continuous hinge which is formed from a thin section of a flexible material, for example a plastic or thermoplastic or polyester, joining the two plates or fittings of the hinge, which as depicted would support insertion of the upper and lower elements. It would also be evident that a material living hinge may be implemented such as from a plastic, thermoplastic or polyester, or fabric for example attached to the upper and lower elements.

Also depicted are first and second snap fit hinges in fourth and fifth images 500D and 500E. In fourth image 500D one part has cylindrical rods to which “clips” or “clasps” are fitted through applying pressure till the “clip” snaps onto the rod. Fifth image 500E depicts a variant wherein each projection from a plate of the hinge has a recess on one side and a projection on the other such that they will snap fit together. By virtue of the asymmetry in recess/projection then a single piece part is manufactured and used in a first orientation and one 180° rotated around. Similarly, the hinge depicted in fourth image 500D may be designed such that when integrated with the lifting device element then two identical manufactured elements may be assembled as described in respect of FIG. 4 may be employed such that the “clips” on one side on one element clip to the rod on the other side of the other element and that the “clips” on the other element clip to the rod on the other element. In this manner the upper and bottom elements are the same manufactured part but with one inverted relative to the other. It would be evident that other hinges may be employed other than those shown without departing from the scope of the invention.

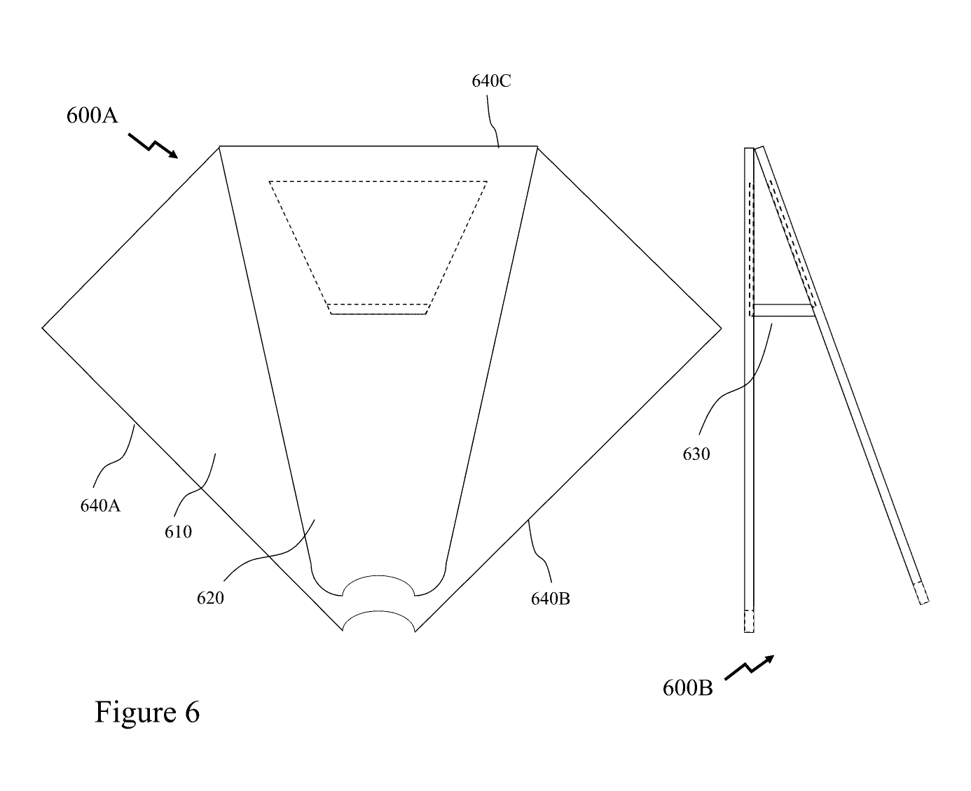

Whilst the lifting devices described and depicted in respect of FIGS. 1 to 4 are most likely to be employed at the corners of a bed or other structure requiring separation of the elements they may also be employed along the edges. In contrast, FIG. 6 in first and second images 600A and 600B depicts an embodiment of the invention in open configuration wherein the upper and lower elements 620 and 610 are now larger and the lifting device is designed to fit within the corner such that first and second edges 640A and 640B are towards two edges of the bed or other structure and third edge 640C is towards the middle, typically, to lift an upper element away from a lower element upon which the lift is disposed in use.

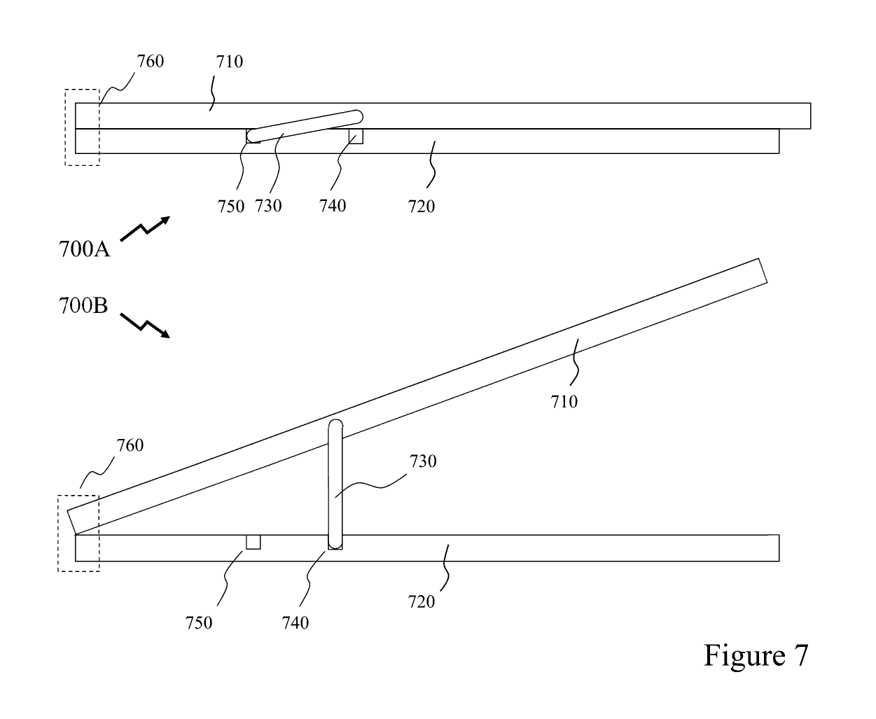

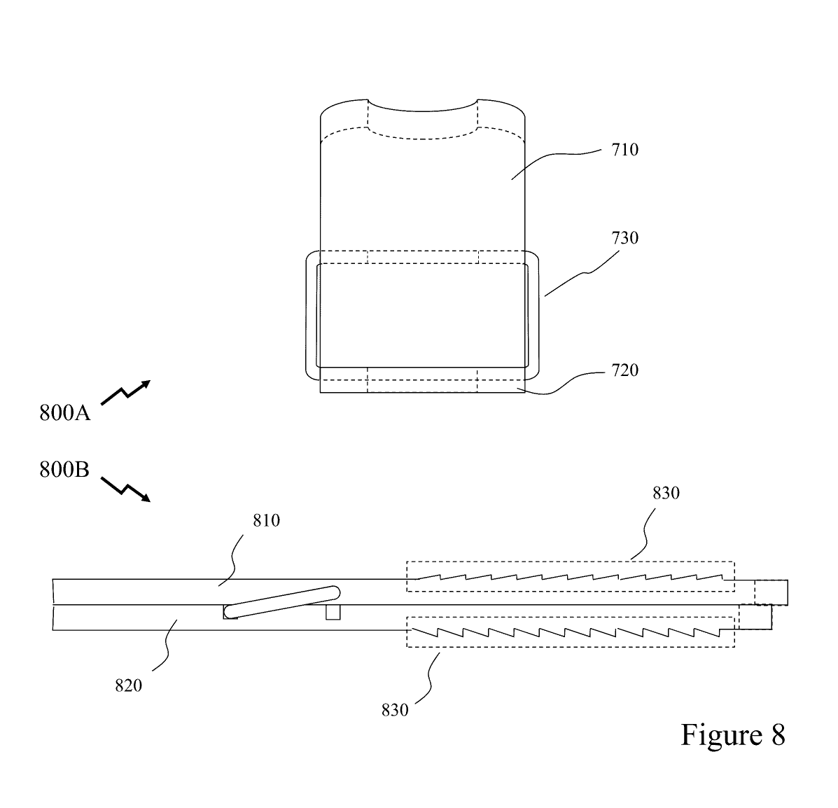

Referring to FIGS. 7 and 8 there are depicted closed side, open side and open end elevations of an embodiment of the invention in first and second images 700A and 700B in FIG. 7 and first image 800A in FIG. 8. In this embodiment of the invention the solid stand portion is replaced with a frame 730 that fits within bores within the upper element 710 and fits within first and second recesses 740 and 750 in lower element 720. In first image 700A the lift is depicted closed so that the frame 730 is retained within the second recess 750. Lifting the upper element 710 results in the frame 730 being similarly pulled/lifted wherein its engagement within first recess 740 retains it in use as the upper, now lifted, component of the structure, e.g. mattress or cushion, is upon it. For example, the upper and lower elements 710 and 720 may be formed from plastic, for example a thermoplastic or polyester, and/or wood whilst frame 730 is metal. As evident in first image 800A in FIG. 8 the frame 730 fits into the bores in the upper element 710 and rests upon the recesses in the lower element 720.

Optionally, the second recess 750 may be omitted in some designs. Further, it would be evident that a further variant may be cross between the support depicted in FIGS. 1 and 2 with the support concept in FIG. 7. In that instance the frame 730 may be solid, fitting into a larger first recess 740 and attached to the upper element 710 via a pair of “lugs” or “pins” that fit the bores within the upper element 710 such that as the upper element 710 is lifted the solid frame lifts up and with shaped upper edge and flat lower edge may be retained in position through the mechanical actions of the upper element 710 onto the angle upper surface of the frame and the frame down onto the lower element 720 from the weight of the element being lifted.

Second image 800B in FIG. 8 depicts another embodiment of the invention wherein the upper and lower elements 810 and 820 now comprise regions 830 with surface texturing to increase “grip” between the respective outer surface of the lifting device and the elements being separated. This region 830 may be all of the exterior surface or a predetermined portion of the exterior surface. Optionally, different regions of the exterior surface may be different textures and/or surface profiles. As depicted the region 830 is contoured through provision of a periodic structure however other embodiments may employ roughened surfaces, particulate surfaces, etc. or other techniques known in the art for improving “friction” or “grip” between the lifting device and the surfaces being lifted or rested upon. As depicted the region 830 may be different on the upper surface to the lower surface. Within embodiments of the invention the upper surface is smooth to allow free movement of the element atop it being lifted.

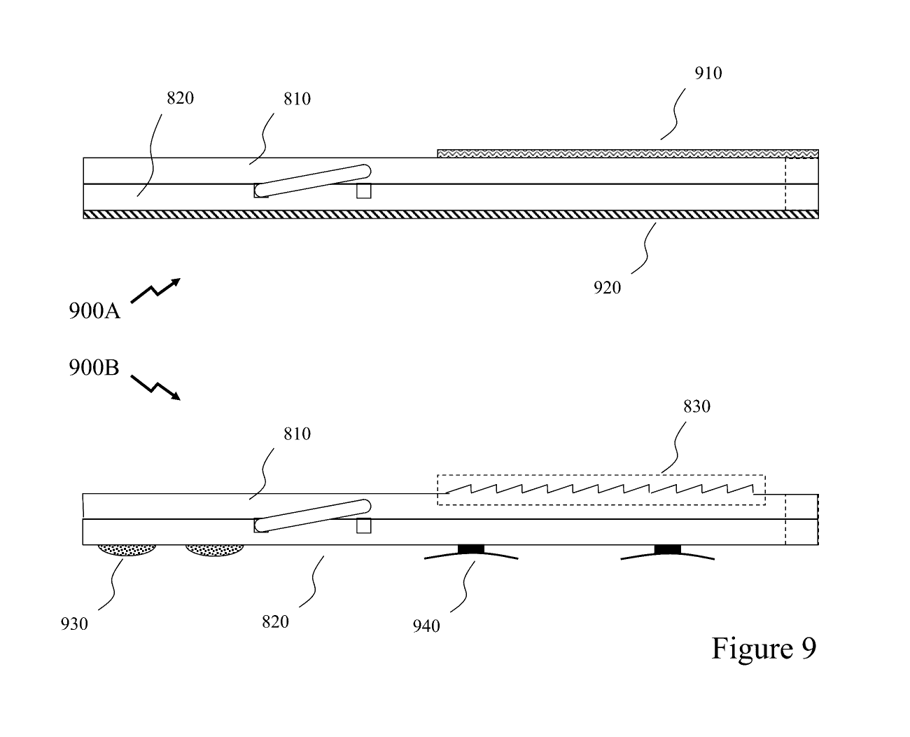

Now referring to FIG. 9 there are depicted first and second lifting devices 900A and 900B respectively employing other features on their external surfaces. As depicted each again comprises upper and lower elements 810 and 820 as discussed and depicted in respect of second image 800B in FIG. 8. First image 900A depicts a lifting device with a first material 910 disposed on the upper external surface of upper element 810 and a second material disposed on the lower external surface of the lower element 820. For example, first material 910 may be a silicone or similar like material for reduced “friction”/“grip.” Second material 920 may be similar but may also be chosen for improved “friction”/“grip” as well as being chosen potentially to protect the surface upon which the lifting device sits. As such the second material 920 may also be selected from materials such as felt, cork, silicone, an elastomer etc. Second image 900B depicts another embodiment of the invention wherein silicone rubber feet 930 are disposed on the lower element 820 to protect the surface the lifting device sits/rests upon and provide “friction”/“grip”. Alternatively, suction cups 940 may be employed to similar effect as may other attachments such as double-sided tape, hook and loop fasteners, etc.

In some embodiments and usage scenarios the lifting device may be attached in order to prevent or limit movement of the lifting device during use etc. In some embodiments and usage scenarios the lifting device may be attached to aid with the closing sequence/process of the lifting device and the lowering of the lifted element as it prevents the bottom element from coming up off the lower surface it is disposed upon with the initial small lifting motion which lifts the foot stand out of its retaining feature and allows the upper lifted object to be lowered back down as the foot stand then does not prevent the upper element and the lifted object motion downwards.

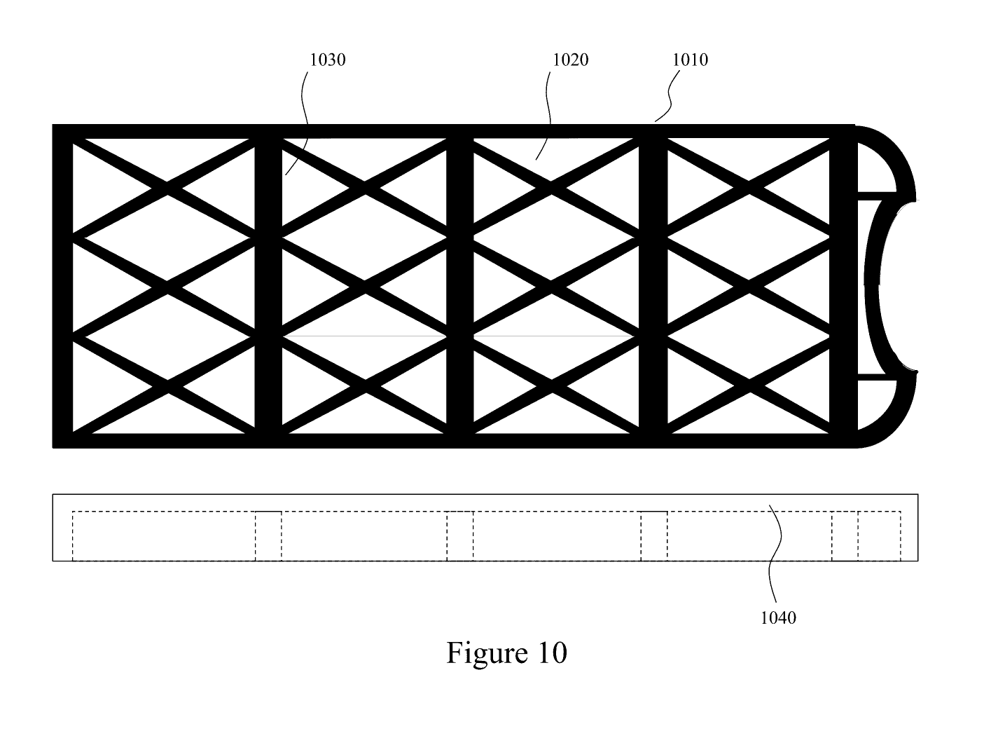

Referring to FIG. 10 there is depicted a lifting device according to an embodiment of the invention depicting the design of an upper or lower element absent any features relating to the stand for simplicity of depiction. As depicted the element comprises an outer wall 1010 within which are diagonal ribs 1020 and lateral ribs 1030 and an upper surface 1040. It would be known to one of skill in the art that such design methodologies allow for the reduction in weight and raw materials consumed in manufacture whilst maintaining strength and rigidity.

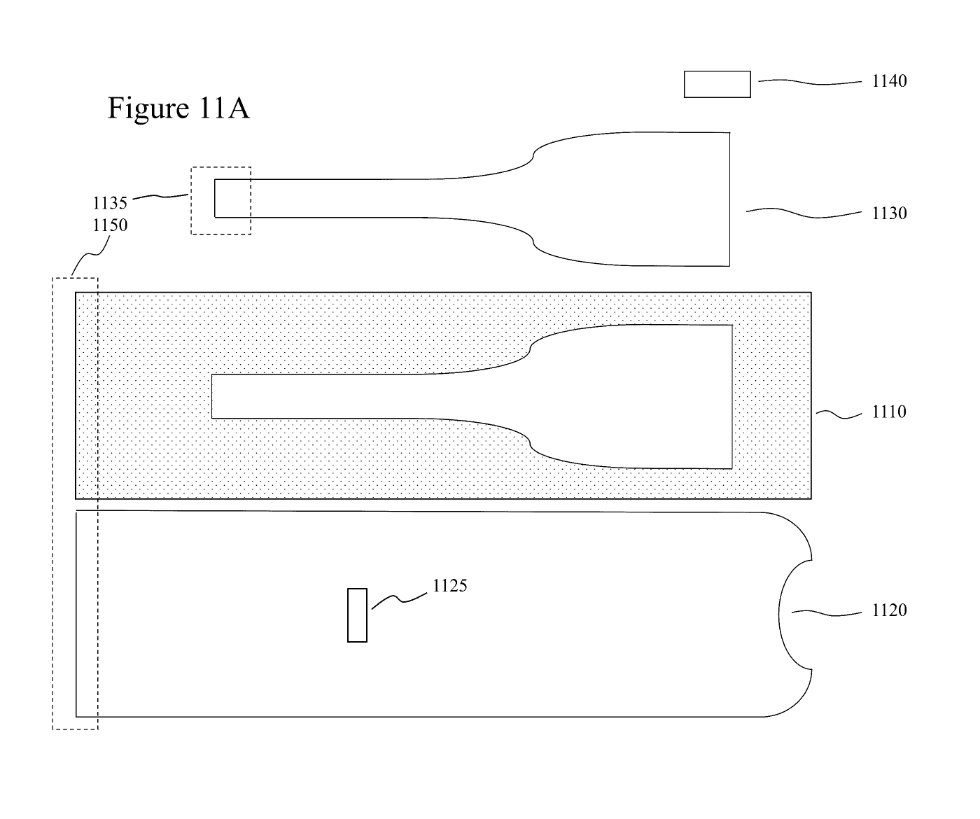

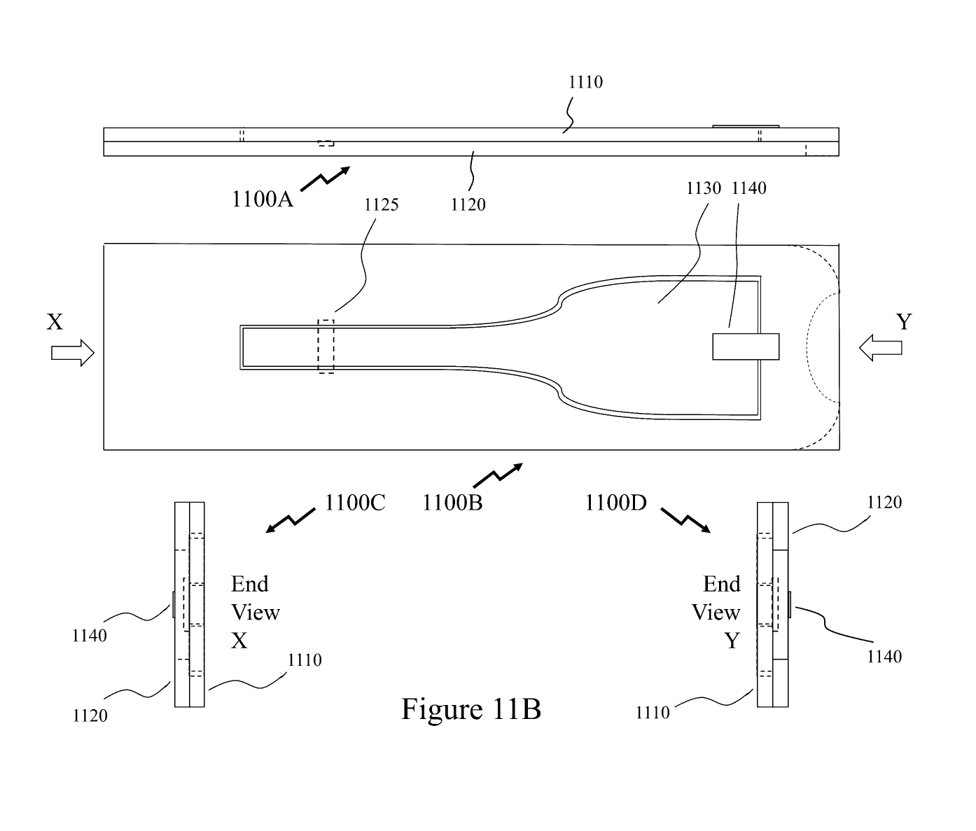

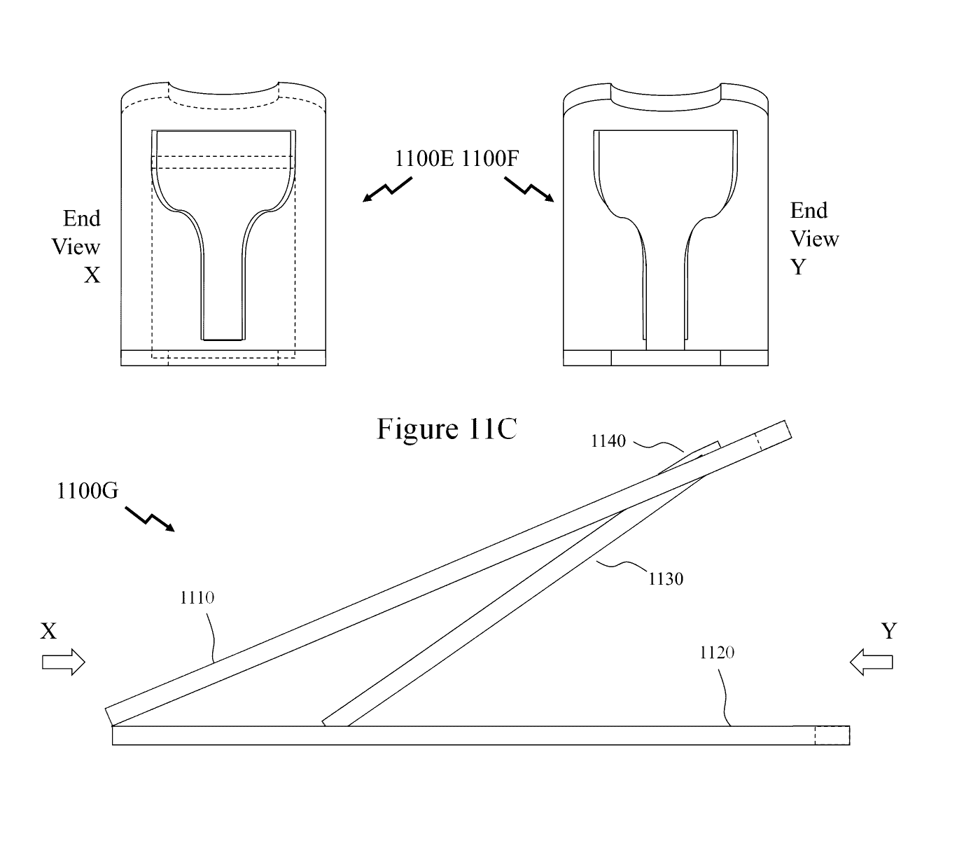

Now referring to FIG. 11A there are depicted piece-parts for a lifting device according to an embodiment of the invention. As depicted there is a base 1120 with a recess 1125 which engages with foot region 1135 of the stand 1130 in the assembled lifting device as depicted in FIG. 11C wherein the lifting device is depicted in open assembled (deployed) configuration. Also depicted in FIG. 11A are top 1110 which has an opening formed within it to allow the stand 1130 to fit within as depicted in closed assembled (storage) configuration in FIG. 11B. Also depicted is biased hinge element 1140 whose functionality is described below in respect of FIG. 11C and the open assembled (deployed) configuration. Top 1110 is depicted stippled to define the opening within it fitting the stand 1130. Omitted from FIG. 11A for clarity is the hinge which joins the base 1120 and top 1110 the ends defined within region 1150 in FIG. 11A.

Referring to FIG. 11B the lifting device according to an embodiment of the invention employing the piece parts depicted in FIG. 11A is shown in the closed position, i.e. in its storage or not in use position. Accordingly, as depicted in front elevation 1100A, plan 1100B, left side elevation 1100C, and right side elevation 1100D the top 1110 is fitted atop the base 1120 with the stand 1130 within the opening within the top 1110. As depicted the rectangular top 1110 fits across the finger recess within the base 1120 such that the user when the lifting device is inserted beneath a mattress, for example, can slide their fingers beneath the end of the top 1110 and lift. In doing so the end of stand 1130 not attached to the top 1110 via the biased hinge element 1140 “drops” down onto the base 1120 such that once lifted past a predetermined point as the top 1110 is lowered the foot region 1135 of the stand 1130 engages the recess 1125 with the base 1120 such that the lifting device is in its open position. The biased hinge element 1140 is formed such that it applies pressure to the stand 1130 as the top 1110 opens such that the stand deploys as within the closed position the biased hinged element is elastically deformed such that it wishes to return to its preferred configuration when the top is raised.

The biased hinge element 1140 may, for example, be formed from a variety of materials including, but not limited to, spring steel which elastically deform as the lifting device closes and then in recovering their geometry “push” the stand down as the lifting device is opened. Alternatively, other means to provide the same functionality may be employed such as torsion springs, for example, and others as known in the art. In other embodiments of the invention the “force” provided by the biased hinge element 1140 may be sufficient to counteract a tendency for the elastic within some fitted sheets, such as those with tighter elastic or tighter fitting, to pin the stand up and prevent it descending fully. Whilst the biased hinge element 1140 is depicted on the upper surface of the top 1110 it would be evident to one skilled in the art that alternatively the biased hinge element 1140 may be upon the lower surface of the top 1110 or there may be biased hinge elements 1140 on both upper and lower surfaces, multiple biased hinge elements 1140 on the upper surface, multiple biased hinge elements 1140 on the lower surface or multiple biased hinge elements 1140 on the upper and lower surface elements. Optionally, the upper and/or lower surfaces of the top 1110 may be profiled such that the biased hinge element(s) 1140 are recessed within the top 1110.

Within embodiments of the invention exploiting the biased hinge element then if placed on the bottom of the stand and lower surface of the upper element it may be appropriate to add an angled cutaway section to both the stand and upper element to improve the action of the biased hinge element, which is in essence a flat spring otherwise known as a leaf spring by providing space for it to deform properly when flat, i.e. the lifting device is in the closed position as this can cause the middle of the biased hinge element to push up into a small triangular shape. If no material is carved away, the biased hinge element pushes up into the material of the stand and/or top and may cause fatigue or reduction in the spring force over time such that it does not spring back fully.

Now referring to FIG. 11C the lifting device according to an embodiment of the invention employing the piece parts depicted in FIG. 11A is shown in the open position, i.e. in its in use position. Accordingly, as depicted in left side elevation 1100E, right side elevation 1100F and front elevation 1100G. Hence, as depicted the top 1110 has been raised, the end of stand 1130 not attached to the top 1110 via the biased hinge element 1140 has “dropped” down onto the base 1120 and the foot region 1135 of the stand 1130 has engaged the recess 1125 with the base 1120 such that the weight of a mattress, for example, on the upper outer surface of the top 1110 is resisted and the lifting device is in its open position.

As depicted within FIGS. 11A to 11C a single biased hinge element 1140 is employed on the upper surface of the top 1110. However, it would be evident that alternatively a single biased hinge element 1140 could be employed on the lower surface of the top 1110, a pair of biased hinge elements 1140 may be employed on the upper and lower surfaces of the top 1110, or one or more biased hinge elements 1140 may be disposed within the stand 1130 and top 1110. In the latter instance a single biased hinge element 1140 may be inserted into slots within the appropriate faces of the stand 1130 and top 1110 or the stand 1130 and base 1110 may be injection molded around the biased hinge element 1140 within another embodiment of the invention.

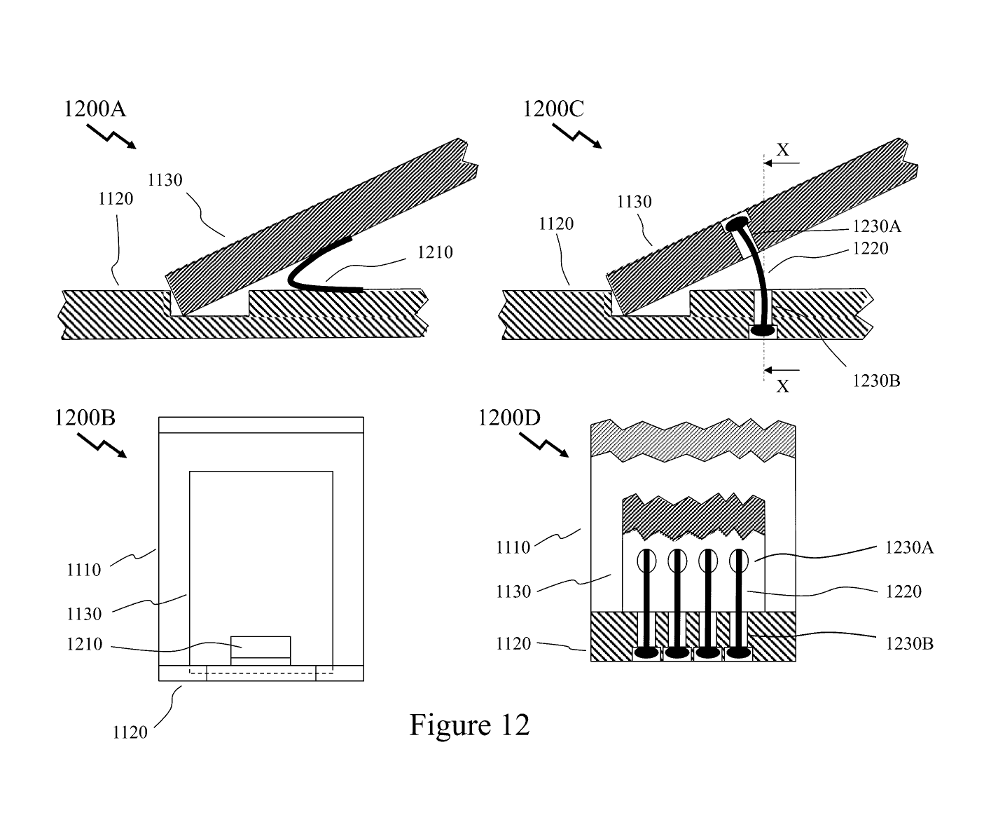

Now referring to FIG. 12 there are depicted first to fourth images 1200A to 1200D respectively with respect to first and second sheet protector elements 1210 and 1220 respectively as employed in conjunction with lifting devices according to embodiments of the invention. A sheet protector element may be employed to prevent a bedsheet or bedsheets from hooking under the foot region of the stand 1130 and preventing it from engaging in the recess (slot) 1125 within the base 1120.

Within other embodiments of the invention according to the design of the sheet protector element(s) then these may in addition to the functionality described supra also assist with the engagement of the stand into the slot. For example, when the sheet protector is elasticated or is non-elasticated and set to the exact length required then it will help to pull the foot right into the slot. The tension in the sheet protector element adds to the pressure of the biased hinge joint of the stand, and together their force counteracts the upward pull of any elasticated sheet(s) for example. Within other embodiments of the invention the sheet protector element or elements may be sufficient in of itself or themselves and accordingly the sheet protector element or elements may be employed alone to ensure the stand engages, even if the stand joint is done in a way that does not apply pressure.

The first sheet protector element depicted in cross-section and end elevation views in first and second images 1200A and 1200B respectively is formed from a tape 1210 which is attached at a predetermined location on the base 1120 and stand 1130 such that the tape 1210 forms a physical barrier in the tapering region between the base 1120 and stand 1130 near the recess 1125 within which the foot region 1135 of the stand 1130 is intended to engage in holding the lifting device within its open configuration. The tape 1210 forming first sheet protector element 1210 may be elasticated or non-elasticated according to the design of the lifting device and the required length of the tape 1210 in the open and closed positions. The tape 1210 may, for example, be glued or stapled to the stand 1130 and base 1120.

The second sheet protector element depicted in cross-section and end elevation views in third and fourth images 1200C and 1200D respectively is formed from a plurality of threads 1220 which are attached at a predetermined location within recesses in the base 1120 and stand 1130 and feed through first holes 1230A within the stand 1130 and second holes 1230B in the base 1120 such that the plurality of threads 1220 form a physical barrier in the tapering region between the base 1120 and stand 1130 near the recess 1125 within which the foot region 1135 of the stand 1130 is intended to engage in holding the lifting device within its open configuration. As with the tape 1210 for the first sheet protector element these threads 1220 may be formed from an elastic or non-elastic material according to their geometry based upon the locations of the first holes 1230A and second holes 1230B within stand 1130 and base 1120 of the lifting device within the open and closed positions or between a maximum opened position (where the top has been lifted past the point it will be retained at in the open position) and closed position. Retention of the threads 1220 may be via gluing, knotting, or crimp beads for example or other techniques known within the art.

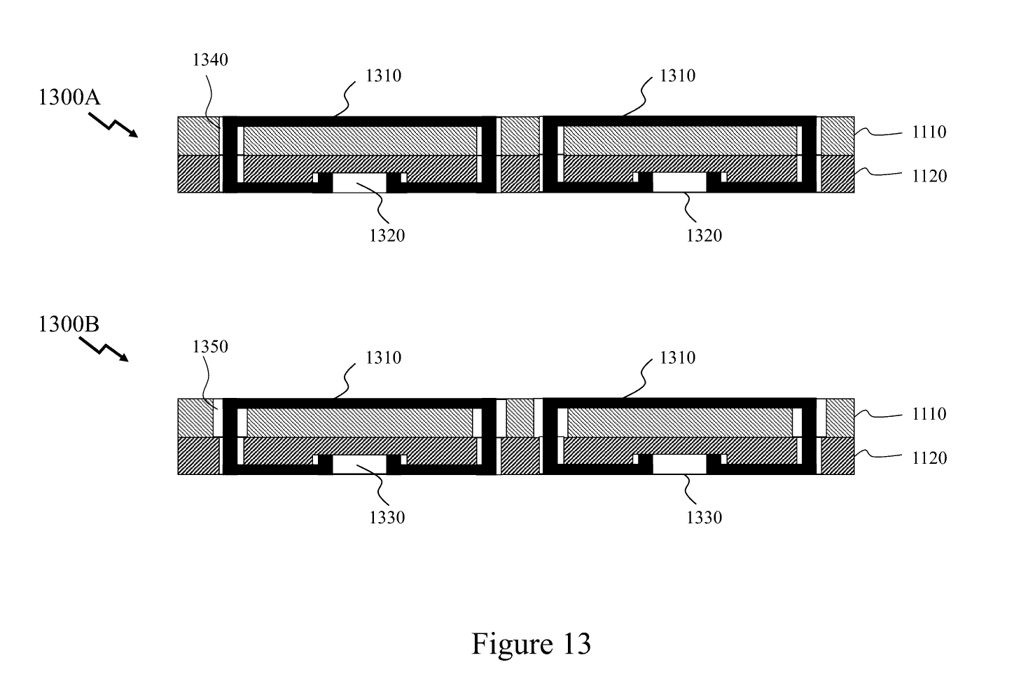

Now referring to FIG. 13 there are depicted first and second hinge configurations 1300A and 1300B respectively according to embodiments of the invention for use in conjunction with a lifting device according to another embodiment of the invention. In each configuration the top 1110 and base 1120 are physically joined via a pair of hinges 1310 which are formed from wire of predetermined diameter and material. In each instance a hinge 1310 fits within a recess 1320 in first configuration 1300A and recess 1330 in second configuration 1300B which is formed within the top 1110 and 1120 by drilling/machining or molding depending upon the material(s) employed for the top 1110 and base 1120 and their manufacturing process. As depicted the hinge 1310 runs from a first region of the lower surface of the base 1120 through the base 1120 and top 1110 and then across the upper surface of the top 1110 before going back through the top 1110 and base 1120 and a second region of the lower surface of the base 1120. In this manner the top 1110 may pivot relative to the base 1120 as required during operation. Optionally, a single hinge may be employed or 3, 4 etc. depending upon the design of the lifting device.

In second configuration 1300B the through holes 1350 within the top 1110 are larger diameter than the holes within the base 1120 whilst in the first configuration the through holes 1330 within the top 1110 are the same diameter than the holes within the base 1120 and in each instance are of a diameter larger than that of the wire forming the hinge 1310. Accordingly, as the top 1110 is lifted there is a range of free motion for the lifting device to open up to a certain angle without deforming the wire. After this angle is reached the lifting resistance increases as now the wire of the hinge 1310 is engaging the edges of the through holes within the top and continued lifting requires deformation of the wire itself. This acts to discourage the user from opening the lifting device further and potentially damaging the hinge or snapping a sheet guard, if fitted.

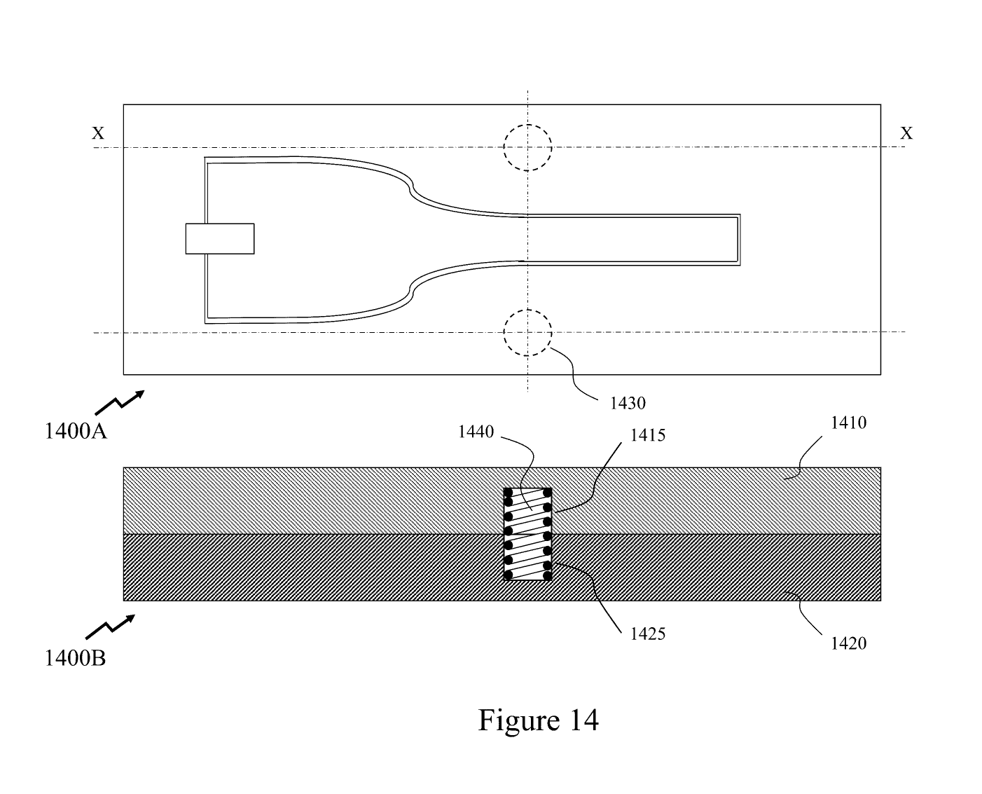

Referring to FIG. 14 there is depicted a configuration exploiting springs to aid the user in operating the lifting device according to an embodiment. As depicted in plan 1400A the device has a similar design to that described supra and depicted in respect of FIG. 11B. In contrast to that design the top 1410 and base 1420 have first and second circular holes 1415 and 1425 at predetermined locations and a spring 1440 disposed within. According to an embodiment of the invention the top 1410 and base 1420 have a closure disposed at the end opposite the hinge to maintain the lifting device within the closed position. Accordingly, the springs 1440 may provide upward lifting pressure for the top 1410 aiding the user in their lifting of the element disposed above the lifting device. Alternatively, the springs 1440 may provide upward lifting pressure for the top 1410 reducing the downward pressure of the element disposed above the lifting device such that when the user releases the foot to close/collapse the lifting device it does not collapse fully or apply as much pressure. Accordingly, depending upon the total spring force in the closed state when the spring(s) are compressed a mattress may be down fully or the user may need to apply downward pressure and close a closure to lock the device closed.

Within the embodiment of the invention described and depicted within FIGS. 11A to 11C and variants thereof the biased hinge element may form the sole joining means between the stand and upper element of the lifting device. This biased hinged element may, for example, be formed from a variety of materials including, but not limited to, spring steel or flat metal strapping which elastically deform as the lifting device closes and then in recovering their geometry “push” the stand down as the lifting device is opened. Alternatively, other means to provide the same functionality may be employed such as torsion springs, for example, and others as known in the art. In other embodiments of the invention the “force” provided by the biased hinge element 1140 may be sufficient to counteract a tendency for the elastic within some fitted sheets, such as those with tighter elastic or tighter fitting, to pin the stand up and prevent it descending fully.

Within the embodiments of the invention described and depicted supra in respect of FIGS. 1 to 14 the top element and bottom element of the lifting device are pivotally attached to one another at one end. Within the preceding description this may be formed by a spring, hinge, living hinge, etc. Within other embodiments of the invention it may be formed from a metal wire “staple.”

Within the preceding description the lifting device has been described as a discrete assembly that is inserted before a lifting operation and retained in place after the lifting operation. For example, in the instance of making a bed and tucking a sheet in under a mattress then the lifting device allows the sheets to be tucked in between the upper and lower elements and then closed such that the lifting device stays in situ. Alternatively, the lifting device may be inserted and removed for subsequent re-use in instances such as lifting cushions or other furniture elements, etc. In the instances where they are left in situ such as making a bed then 1, 2, 3, 4 or perhaps more of the lifting devices may be employed such that a low cost design and manufacturing methodology is beneficial of which embodiments of the invention support.

In other instances, the lifting device may be integrated within an item. For example, the base or box spring of a bed may have these attached and/or integrated with it such that once a mattress is placed atop it a user can easily lift the corner, for example. Within other embodiments of the invention multiple lifting devices may be disposed along, for example, an edge of a sofa or bed exposing an interior of the base for storage and/or cleaning.

In other instances, the lifting device may enclose completely or in part with a covering such as one from a fabric matching the material on the item of furniture for example to blend the lifting device within the overall assembly visually.

Within the embodiments of the invention depicted in respect of FIGS. 1 to 6 the stand descends from the upper element as it is raised away from the lower element. It would be evident that in other embodiments of the invention that the stand may rise from the lower element through strings, elastic elements, etc. In either case the thickness, material, and design of the stand may be established independent of the material(s) selected for the upper and lower elements. The stand may be attached to the upper element by a hinge in some embodiments of the invention or through other attachment means such as magnets or through a combination of both such that hinge pivots open on a hinge but is then “held” in position through magnets disposed in the stand and the upper element. The top of the stand has an angle such that its upper surface is parallel to the upper element's lower surface in the open position. This angle, defined by the geometry of the upper and lower elements, geometry of the stand, placement of the stand, etc. may for example be 10°, 15°, 20°, 25°, 30° or 45°. In some embodiments of the invention the stand is perpendicular to the lower element when the lifting device is in the open position, in others it may be perpendicular to the lower surface of the upper element such that the force from the lifted object is directed axially along the stand to its support within the lower element. In some embodiments of the invention the stand fits within a recess within the upper element, in others within a recess in the lower element, and within yet others within recesses in both the upper and lower elements such that the lower and upper elements close together in the closed position. In other embodiments of the invention this may be varied such that the closed position has a small angle between the upper and lower elements and there are no recesses for “storing” the stand in the closed configuration.

Within other embodiments of the invention the stand may be angled from front to back to provide an advantage that it now doubles as the closing mechanism. In this manner, the user is now no longer required to reach under the mattress in order to collapse the stand and may close the lifting device with a single hand. To close the lifting device, the user may reach between the top and bottom plates with their palm facing up, lift slightly at the outer edge, for example with heel of hand, and push on the foot stand with their fingertips to move the foot upwards. Where the stand fits within a cut-out/opening/slot in the upper element then the stand may be pushed up into it and the assembly lowered into the closed position.

It would be evident that embodiments of the invention may be provided in a range of physical sizes overall exploiting any relative dimensions and radii etc. described supra in respect of FIGS. 1 to 10 such that, for example, the length of the lifting device may be 100 mm, 125 mm, 150 mm, 200 mm, 300 mm, 380 mm, 460 mm, 500 mm or 610 mm for example (4″, 5″, 6″, 8″, 12″, 15″, 18″ or 24″) and it's lateral dimensions may be, for example, 50 mm, 75 mm, 100 mm, 125 mm, or 150 mm (2″, 3″, 4″, 5″, or 6″). With respect to FIG. 6 the upper portion of the lifting device may be 100 mm, 125 mm, 150 mm, or 200 mm (4″, 5″, 6″, or 8″) for example whilst the lower portion of the lifting device may have a wider/longer footprint which may be 200 mm, 300 mm, 380 mm, 460 mm, or 500 mm for example (8″, 12″, 15″, 18″ or 24″) for example. Whilst the designs in FIGS. 1 to 5 and FIGS. 7-10 are essentially elongated higher aspect ratio lifting devices, FIG. 6 depicts a lower aspect ratio lifting device (length/width). It would be evident, however, that other dimensions, aspect ratios, cross-section geometries etc. may be employed without departing from the scope of the invention. Further, whilst the geometries depicted are essentially rectangular and square, it would be evident that other shapes may be employed including elliptical, triangular, regular polygons, irregular polygons and non-geometric for example.

It would be evident that embodiments of the invention may be provided to support a range of weights of objects lifted. For example, whilst a large mattress may weigh approximately 140 kg (approximately 300 lbs) the weight lifted in a corner may be only ˜18 kg, 22 kg, 27 kg (˜40 lb, ˜50 lb, ˜60 lb) or perhaps ˜45 kg (˜100 lbs) along a side. However, in other embodiments the lifting device may only be lifting a lower range of weights, e.g. cushions on a sofa for example. In such instances the lifting device may be specified for ˜10 kg (˜20 lbs) or ˜15 kg (˜30 lbs).

Whilst the elements forming the construction of the lifting devices depicted in respect of FIG. 10 are essentially single piece with optional coatings it would be evident to one of skill in the art that the construction may be generalized to one of a scaffold, a shell and a casing wherein the shell and/or casing may be implemented or not implemented. Typically, the construction of the lifting device is such that they employ a scaffold or scaffolds that provide rigidity to the lifting devices in those regions requiring it and this may be surrounded completely or partially by a shell and, optionally, a casing to provide the external surfaces as appropriate. However, in some embodiments of the invention a scaffold may be employed such as a variant of FIG. 10 wherein the outer wall 1010, diagonal ribs 1020, and lateral ribs 1030 are provided but the upper surface 1040 is not. The scaffolds being joined by the hinges and comprising the handles.

The casing may be formed during the same manufacturing step as the scaffold or it may be formed separately and combined. The shell and/or scaffold may be formed from a single material such as wood, plastic, or metal whilst in other embodiments of the invention the shall and/or scaffolding may be formed from multiple materials and the materials for a scaffold may be different from those of the shell. Around these an outer casing may be provided which may be coloured, transparent or, according to the complexity acceptable, the outer casing may be formed from a variety of colours and/or be patterned for a specific design. Typically, such colours will be part of a silicone or other elastomer employed in forming the casing, although in other embodiments of the invention the casing may be coloured once formed, and a protective fluid proof, non-toxic, non-abrasive coating formed atop these applied colours.

Beneficially, medical grade silicone is clear, thereby removing the requirement for any additional coating (e.g. food grade urethane) in conjunction with pigmented silicones. Accordingly, a lifting device may be medical grade, employing a clear silicone coating formed from an initial soft silicone, e.g. 20 durometer, with a micro-layer (spray coated for example) of high durometer medical grade silicone, for example 70-90 durometer, to create a “slippery” surface. Optionally, one or more parts of a surface may be protected to leave them sticky or a different durometer silicone applied for a “sticky” surface. According to the casing material or scaffold material then it may be cleaned or sterilized to a medical standard, for example through a domestic dishwasher cycle. Alternatively, the device may be chemically cleaned or sterilized to a medical standard according to the requirements in some applications. For example, a stainless steel scaffold would not require a coating whereas some plastics, wood, etc. would.

Within embodiments of the invention the lifting device is intended for use in conjunction with bedding, soft furnishings, etc. and hence it would be desirable for the lifting device to be absent sharp corners, surfaces etc. In other embodiments of the invention some portions of the design may be abrupt, have small radii etc.

It would be evident that in some embodiments of the invention the lower element may be formed as part of the base of an item of furniture, e.g. a mattress base, and that the upper element is inserted into a sleeve within the lower surface of an item placed onto the base, such as a mattress for example.

The upper element, and in some embodiments of the invention the lower element, is intended to be gripped/held by a user or engaged by the user. Accordingly, the ends of the lifting device engaging with the user's fingers and/or hand may be textured for enhanced grip, may be shaped to aid gripping, etc. or may employ holes, recesses or other features to aid in this. In other embodiments, simply making the upper element longer than the lower element may provide the same function.

Within the embodiments of the invention described and depicted supra in respect of FIGS. 1 to 10 the location of the stand between the upper and lower elements has been depicted towards the hinge. In this configuration the large free space between the elements and in front of the stand allows the user to tuck in a sheet beneath a mattress prior to closing the lifting element such that the sheets are now between the upper and lower elements. In this manner the lifting device allows for the making of the bed whilst it is in situ in the open configuration and does not interfere with the subsequent position of the mattress in the closed configuration.

Within the embodiments of the invention described and depicted supra in respect of FIGS. 1 to 14 both upper and lower elements have been depicted. However, within other embodiments of the invention the lower element may be omitted such that the stand in the open configuration sits down upon a lower portion of bed base, for example. In this instance the upper element may be retained in position on the underside of the mattress, for example, through an attachment means such as loop-and-hook, e.g. Velcro™, for example or a fabric pocket on the underside of the mattress.

Within a further embodiment of the invention the upper element is simply the attachment means for the pivoting stand to the upper element, e.g. mattress, without any substantial length to it. In this instance in order to ensure appropriate action diagonal pairs of elements may be linked via an elastic element, string etc.

Within the embodiments of the invention described and depicted supra in respect of FIGS. 1A to 10 then it is evident that no collapsing mechanism is provided and the user is required to, in some instances, push on the stand to collapse the device. Alternatively, an elastic or string could be attached to the stand, which the user can pull to knock the stand out of place and cause the device to collapse into its closed position. Within such embodiments it is desirable, but not essential, that no strings or elastics can protrude from the top plate since bedding will cover it while in use within such applications. However, they could come through a channel underneath the bottom plate, for example. For example, a string could attach to the bottom of the stand, run along the bottom plate backwards towards the hinge, through the hinge and then down underneath, running forwards towards the front along a channel or groove in the lower plate, such that the end protrudes out the front and can be grasped and pulled by the user. A handle could be attached to the end of the string making it easier to find and grasp. Other means of collapsing the foot can be envisioned without departing from the underlying concept of knocking the stand out of place.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A lifting device comprising:
a lower element having a first end, a second end, an upper surface and a lower surface;
an upper element having a first end, a second end, an upper surface and a lower surface;
a hinge joining the first end of the lower element to the first end of the upper element; and
a stand pivotally attached to a predetermined location on the upper element, wherein
in a first closed configuration the upper surface of the lower element and the lower surface of the upper element are disposed adjacent to each other and the stand is contained within at least one of a recess in the upper surface of the lower element, a recess in the lower surface of the upper element, and a cut-out in the upper element; and
in a second configuration the lower and upper elements are disposed at a predetermined angle with respect to each other and the stand is disposed between the lower and upper elements and retained in position by a feature within the upper surface of the lower element such that the second configuration is maintained when a load is applied to the upper surface of the upper element when the lifting device is mounted onto a surface.

2. The lifting device according to claim 1, wherein
the lower element forms a predetermined portion of an item of furniture.

3. The lifting device according to claim 1, wherein
the lower element forms a predetermined portion of a first item of furniture; and
the upper element is at least one of part of and fitted to a second item of furniture.

4. The lifting device according to claim 1, wherein
the upper and lower elements are the same piece part when manufactured and each comprises half of the hinge.

5. The lifting device according to claim 1, wherein
the upper and lower elements are portions of the same piece part when manufactured and the hinge is a living or continuous hinge concurrently formed with the upper and lower elements.

6. A lifting device comprising:
a lower element having a first end, a second end, an upper surface and a lower surface;
an upper element having a first end, a second end, an upper surface and a lower surface;
a hinge joining the first end of the lower element to the first end of the upper element; and
a stand pivotally attached to a predetermined location on the upper element, wherein
in a first closed configuration the upper surface of the lower element and the lower surface of the upper element are disposed adjacent to each other and the lower end of the stand is disposed within at least one of a first recess and a cut-out in the upper surface of the lower element; and
in a second configuration the lower and upper elements are disposed at a predetermined angle with respect to each other and the stand is disposed between the lower and upper elements and retained in position within a second recess within the upper surface of the lower element such that the second configuration is maintained when a load is applied to the upper surface of the upper element when the lifting device is mounted onto a surface.

7. The lifting device according to claim 6, wherein
the lower element forms a predetermined portion of an item of furniture.

8. The lifting device according to claim 6, wherein
the lower element forms a predetermined portion of a first item of furniture; and
the upper element is at least one of part of and fitted to a second item of furniture.

9. The lifting device according to claim 6, wherein
the upper and lower elements are the same piece part when manufactured and each comprises half of the hinge.

10. The lifting device according to claim 6, wherein
the upper and lower elements are portions of the same piece part when manufactured and the hinge is a living or continuous hinge concurrently formed with the upper and lower elements.

11. A lifting device comprising:
a lower element having a first end, a second end, an upper surface and a lower surface;
an upper element having a first end, a second end, an upper surface and a lower surface;
a hinge joining the first end of the lower element to the first end of the upper element; and
a stand pivotally attached to a predetermined location on the upper element, wherein
in a first closed configuration the upper surface of the lower element and the lower surface of the upper element are disposed at a first predetermined angle with respect to each other and the lower end of the stand is disposed within the region between the upper surface of the lower element and the lower surface of the upper element; and
in a second configuration the lower and upper elements are disposed at a predetermined angle with respect to each other and the stand is disposed between the lower and upper elements and retained in position when a load is applied to the upper surface of the upper element when the lifting device is mounted onto a surface.

12. The lifting device according to claim 11, wherein
the hinge is an offset hinge; and
the first predetermined angle is approximately zero.

13. The lifting device according to claim 11, wherein
the stand is disposed towards the hinged end of the device such that if employed in the process of making a bed the sheet or sheets may be tucked under the mattress being lifted and retained between the upper and lower elements when the device is in a closed configuration.
